(19) United States
(12) Patent Application Publication
(10) Pub. No.: US 2023/0231833 A1
(43) Pub. Date: Jul. 20, 2023

(54) SYSTEM AND METHOD FOR MANAGING REMOTE ACCESS TO A CLOUD-BASED VIRTUAL COMPUTER NETWORK USING A VIRTUAL JUMPBOX INFRASTRUCTURE

(71) Applicant: VMWARE, INC., Palo Alto, CA (US)

(72) Inventors: Jon Cook, San Jose, CA (US); Prabhat Kumar, Bangalore (IN); Saket Singh, Bangalore (IN)

(21) Appl. No.: 17/718,367

(22) Filed: Apr. 12, 2022

(30) Foreign Application Priority Data
Jan. 19, 2022 (IN) 202241003054

(51) Int. Cl. H04L 9/40; H04L 47/762; H04L 47/783

(52) U.S. Cl. CPC H04L 63/0428; H04L 63/205; H04L 47/762; H04L 47/783

(57) ABSTRACT

System and computer-implemented method for managing remote access to managed components in a cloud-based virtual computer network uses a virtual jumpbox infrastructure to establish a cryptographic network protocol connection between the virtual jumpbox infrastructure and the cloud-based virtual computer network on behalf of an user interface making a request for remote access to the cloud-based virtual computer network. After the cryptographic network protocol connection has been established, communication data between the user interface and a target managed component in the cloud-based virtual computer network is automatically moderated at the virtual jumpbox infrastructure at a data path that is not within the cryptographic network protocol connection. The automatic moderation includes at least one of inserting new information into the communication data and removing existing information from the communication data.

### RELATED APPLICATION

Benefit is claimed under 35 U.S.C. 119(a)-(d) to Foreign Application Serial No. 202241003054 filed in India entitled “SYSTEM AND METHOD FOR MANAGING REMOTE ACCESS TO A CLOUD-BASED VIRTUAL COMPUTER NETWORK USING A VIRTUAL JUMPBOX INFRASTRUCTURE”, on Jan. 19, 2022, by VMware, Inc., which is herein incorporated in its entirety by reference for all purposes.

### BACKGROUND

Various computing architectures can be deployed in a public cloud as a cloud service. As an example, one or more software-defined data centers (SDDCs) may be deployed in a dedicated private cloud environment of a public cloud for an entity or customer via a cloud service provider, e.g., a VMware Cloud Provider™, where each SDDC may include one or more clusters of host computers. Such dedicated private cloud environments may be managed by a cloud service provider, which uses a public cloud operated by a public cloud provider.

In a dedicated private cloud environment of a public cloud, there is a need for the cloud service provider to control administrator access for compliance and security reasons. However, implementing administrator access control in such a private cloud environment presents various challenges. Some of these challenges may be due in part to the fact that multiple compensating controls may be needed to meet compliance standards. Other challenges may be due in part to the fact that various components in the private cloud environment must be monitored for a full audit, where these various components may require different access information.

One such challenge is that sometimes it may be difficult to provide compensating compliance controls on shared accounts, such as admin or root. These accounts are particularly important, so being able to attribute shared admin operations to a specific user, or offering a way to moderate access to these shared accounts is important. As an example, a cloud service provider may let a support engineer have access to a shared account, but the cloud service provider may not want the support engineer to have access to potentially sensitive information, such as a password, that would be accessible or even needed to perform operations as the shared administrator. So even while the cloud service provider want select people to perform certain operations using a shared account, the cloud service provider may not want to give them any sensitive information while they execute those operations. A further example might be that of an embedded database, which may need to be accessed when one logs in as an admin, but the cloud service provider does not want to expose the password for the database.

### SUMMARY

System and computer-implemented method for managing remote access to managed components in a cloud-based virtual computer network uses a virtual jumpbox infrastructure to establish a cryptographic network protocol connection between the virtual jumpbox infrastructure and the cloud-based virtual computer network on behalf of an user interface making a request for remote access to the cloud-based virtual computer network. After the cryptographic network protocol connection has been established, communication data between the user interface and a target managed component in the cloud-based virtual computer network is automatically moderated at the virtual jumpbox infrastructure at a data path that is not within the cryptographic network protocol connection. The automatic moderation includes at least one of inserting new information into the communication data and removing existing information from the communication data.

A computer-implemented method for managing remote access to managed components in a cloud-based virtual computer network comprises receiving, at a virtual jumpbox infrastructure, a request for remote access to the cloud-based virtual computer network from a user interface in a user device, establishing a cryptographic network protocol connection between the virtual jumpbox infrastructure and the cloud-based virtual computer network on behalf of the user interface in response to the request for remote access, and after the cryptographic network protocol connection has been established, automatically moderating communication data between the user interface and a target managed component in the cloud-based virtual computer network at the virtual jumpbox infrastructure at a data path that is not within the cryptographic network protocol connection, wherein the automatically moderating includes at least one of inserting new information into the communication data and removing existing information from the communication data. In some embodiments, the steps of this method are performed when program instructions contained in a computer-readable storage medium are executed by one or more processors.

A system in accordance with an embodiment of the invention comprises memory and at least one processor configured to receive, at a virtual jumpbox infrastructure, a request for remote access to the cloud-based virtual computer network from a user interface in a user device, establish a cryptographic network protocol connection between the virtual jumpbox infrastructure and the cloud-based virtual computer network on behalf of the user interface in response to the request for remote access, after the cryptographic network protocol connection has been established, and automatically moderate communication data between the user interface and a target managed component in the cloud-based virtual computer network at the virtual jumpbox infrastructure at a data path that is not within the cryptographic network protocol connection, wherein the automatic modulation includes at least one of inserting new information into the communication data and removing existing information from the communication data.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a computing system in accordance with an embodiment of the invention.

FIG. 2 is a diagram of a cloud-based virtual computer network that may be implemented in the computing system shown in FIG. 1 in accordance with an embodiment of the invention.

FIG. 3 is a more detailed diagram of the computing system of FIG. 1 in accordance with an embodiment of the invention.

FIG. 4 is a diagram of components of a virtual jumpbox secure shell (SSH) terminal service in a virtual jumpbox infrastructure of the computing system of FIG. 1 in accordance with an embodiment of the invention.

FIG. 5 is a diagram of components of a transport unit in the virtual jumpbox SSH terminal service shown in FIG. 4 in accordance with an embodiment of the invention.

FIG. 6 is a flow diagram of a process of creating an SSH session with a point-of-presence (POP) device in the cloud-based virtual computer network from an SSH user interface (UI) to remotely access target managed components in the cloud-based virtual computer network in accordance with an embodiment of the invention.

FIG. 7 is a flow diagram of a process of sending outgoing (input) data from a registered SSH UI to a target managed component in the cloud-based virtual computer network through an established SSH session between an SSH proxy core in the virtual jumpbox SSH terminal service and the POP device in the cloud-based virtual computer network in accordance with an embodiment of the invention.

FIG. 8 is a flow diagram of a process of receiving incoming (output) data from a target managed component in the cloud-based virtual computer network to an SSH UI through an established SSH session between the SSH proxy core in the virtual jumpbox SSH terminal service and the POP device in the cloud-based virtual computer network in accordance with an embodiment of the invention.

FIG. 9 is a process flow diagram of a computer-implemented method for managing remote access to managed components in a cloud-based virtual computer network in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

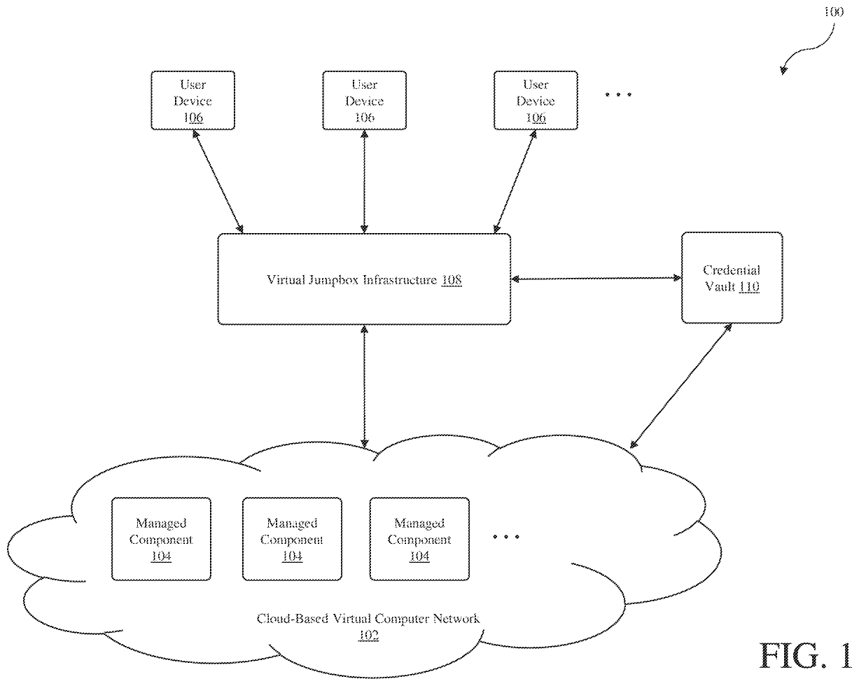

Turning now to FIG. 1, a computing system 100 in accordance with an embodiment of the invention is shown. The computing system 100 includes a cloud-based virtual computer network 102, which resides in a public cloud. The cloud-based virtual computer network 102 may be provided a cloud service provider, which may be different from the cloud provider that provides the public cloud. The cloud-based virtual computer network 102 may be any virtual computer network that resides in a public cloud, such as a virtual private cloud (VPC) or a virtual network (VNET).

As shown in FIG. 1, the cloud-based virtual computer network 102 includes multiple managed components 104, which may be remotely accessed by users, such as administrators, via user devices 106. The user devices 106 can be any computing devices, such as desktop or laptop computers, that can access the Internet. The managed components 104 may vary depending on the type and configuration of the cloud-based virtual computer network 102. As an example, the managed components 104 may include, but not limited to, hypervisors, virtualization managers, logical network managers and edge services gateways, which are described below.

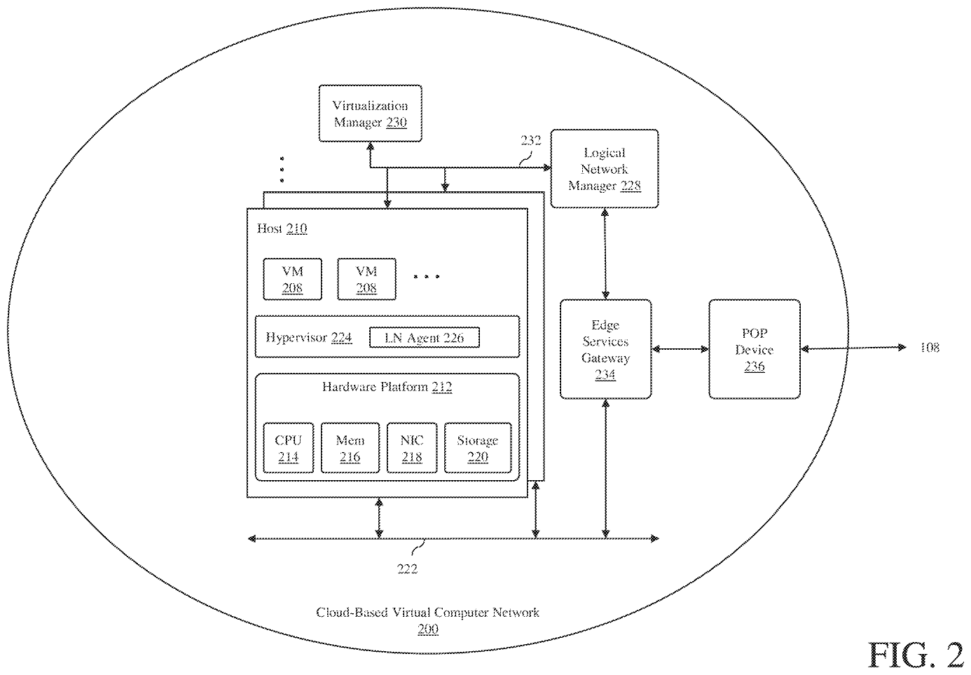

Turning now to FIG. 2, a cloud-based virtual computer network 200 that may be implemented in the computing system 100 in accordance with an embodiment of the invention is illustrated. Thus, the cloud-based virtual computer network 200 is an example of the cloud-based virtual computer network 102 shown in FIG. 1. In this example, the cloud-based virtual computer network 200 is a virtual private cloud (VPC), for example, a VMware Cloud™, which is configured as a software-defined data center (SDDC) for use by a single tenant. As shown in FIG. 2, the cloud-based virtual computer network 200 includes one or more host computer systems (“hosts”) 210. The hosts may be constructed on a server grade hardware platform 212, such as an x86 architecture platform, which are provided by a cloud provider of a public cloud on which the cloud-based virtual computer network 200 is deployed. As shown, the hardware platform of each host may include conventional components of a computing device, such as one or more processors (e.g., CPUs) 214, system memory 216, a network interface 218, and storage 220. The processor 214 can be any type of a processor commonly used in servers. The memory 216 is volatile memory used for retrieving programs and processing data. The memory 216 may include, for example, one or more random access memory (RAM) modules. The network interface 218 enables the host 210 to communicate with other devices that are inside or outside of the cloud-based virtual computer network 200 via a communication medium, such as a network 222. The network interface 218 may be one or more network adapters, also referred to as network interface cards (NICs). The storage 220 represents one or more local storage devices (e.g., one or more hard disks, flash memory modules, solid state disks and/or optical disks), which may be used to form a virtual storage area network (SAN).

Each host 210 may be configured to provide a virtualization layer that abstracts processor, memory, storage and networking resources of the hardware platform 212 into the virtual computing instances, e.g., virtual machines 208, that run concurrently on the same host. The virtual machines run on top of a software interface layer, which is referred to herein as a hypervisor 224, that enables sharing of the hardware resources of the host by the virtual machines. One example of the hypervisor 224 that may be used in an embodiment described herein is a VMware ESXi™ hypervisor provided as part of the VMware vSphere® solution made commercially available from VMware, Inc. The hypervisor 224 may run on top of the operating system of the host or directly on hardware components of the host. For other types of virtual computing instances, the host may include other virtualization software platforms to support those virtual computing instances, such as Docker virtualization platform to support “containers”.

In the illustrated embodiment, the hypervisor 224 includes a logical network (LN) agent 226, which operates to provide logical networking capabilities, also referred to as “software-defined networking” (SDN). Each logical network may include software managed and implemented network services, such as bridging, L3 routing, L2 switching, network address translation (NAT), and firewall capabilities, to support one or more logical overlay networks in the cloud-based virtual computer network 200. The logical network agent 226 receives configuration information from a logical network manager 228 (which may include a control plane cluster) and, based on this information, populates forwarding, firewall and/or other action tables for dropping or directing packets between the virtual machines 208 in the host 210, other virtual machines on other hosts, and/or other devices outside of the cloud-based virtual computer network 200. Collectively, the logical network agent 226, together with other logical network agents on other hosts, according to their forwarding/routing tables, implement isolated overlay networks that can connect arbitrarily selected virtual machines with each other. Each virtual machine may be arbitrarily assigned a particular logical network in a manner that decouples the overlay network topology from the underlying physical network. Generally, this is achieved by encapsulating packets at a source host and decapsulating packets at a destination host so that virtual machines on the source and destination can communicate without regard to underlying physical network topology. In a particular implementation, the logical network agent 226 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols such as stateless transport tunneling (STT), Network Virtualization using Generic Routing Encapsulation (NVGRE), or Geneve, instead of, or in addition to, VXLAN.

The cloud-based virtual computer network 200 also includes a virtualization manager 230 that communicates with the hosts 210 via a management network 232. In an embodiment, the virtualization manager 230 is a computer program that resides and executes in a computer system, such as one of the hosts, or in a virtual computing instance, such as one of the virtual machines 208 running on the hosts. One example of the virtualization manager 230 is the VMware vCenter Server® product made available from VMware, Inc. In an embodiment, the virtualization manager is configured to carry out administrative tasks for a cluster of hosts that forms an SDDC, including managing the hosts in the cluster, managing the virtual machines running within each host in the cluster, provisioning virtual machines, migrating virtual machines from one host to another host, and load balancing between the hosts in the cluster.

As noted above, the cloud-based virtual computer network 200 also includes the logical network manager 228 (which may include a control plane cluster), which operates with the logical network agents 226 in the hosts 210 to manage and control logical overlay networks in the cloud-based virtual computer network 200. Logical overlay networks comprise logical network devices and connections that are mapped to physical networking resources, e.g., switches and routers, in a manner analogous to the manner in which other physical resources as compute and storage are virtualized. In an embodiment, the logical network manager 228 has access to information regarding physical components and logical overlay network components in the cloud-based virtual computer network. With the physical and logical overlay network information, the logical network manager 228 is able to map logical network configurations to the physical network components that convey, route, and filter physical traffic in the cloud-based virtual computer network 200. In one particular implementation, the logical network manager 228 is a VMware NSX® Manager™ product running on any computer, such as one of the hosts or a virtual machine in the cloud-based virtual computer network 200.

The cloud-based virtual computer network 200 also includes an edge services gateway 234 to control network traffic into and out of the cloud-based virtual computer network 200. In an embodiment, the edge services gateway 234 may be implemented in one of the virtual machines 208 running in the cloud-based virtual computer network 200. One example of the edge services gateway 234 is VMware NSX® Edge™ product made available from VMware, Inc.

In the illustrated embodiment, the cloud-based virtual computer network 200 also includes a point-of-presence (POP) device 236, which is connected to the virtual jumpbox infrastructure 108, that is acting as a bastion host to validate connections to various components in the cloud-based virtual computer network 200, such as the hypervisors 224, the logical network manager 228, the virtualization manager 230 and the edge services gateway 234. Thus, the POP device 236 ensures only trusted connections are made to the various components in the cloud-based virtual computer network 200.

In the cloud-based virtual computer network 200, the managed components that may be accessed by administrators using the user devices 106 include the hypervisors 224, the logical network manager 228, the virtualization manager 230 and the edge services gateway 234. In order to control administrator access to these managed components for compliance and security reasons, the computing system 100 shown in FIG. 1 includes a virtual jumpbox infrastructure 108, which is an interface for the user devices 106 when accessing the managed components in the cloud-based virtual computer network 102, such as the cloud-based virtual computer network 200. Thus, all access activities between the user devices 106 and the managed components 104 in the cloud-based virtual computer network 102 can be recorded and audited. In addition, the virtual jumpbox infrastructure 108 performs moderation operations for compliance and security, such as removing credentials to the managed components 104 in the cloud-based virtual computer network 102 and replacing variables in commands with stored information so that the users do not have to have any knowledge regarding the stored information. In an embodiment, a credential vault 110 is used by the virtual jumpbox infrastructure 108 to insert and detect sensitive information, such as passwords, in data streams to and from target systems, e.g., the hypervisors 224, the logical network manager 228, the virtualization manager 230 and the edge services gateway 234. This credential vault may also be used to create the trust between the virtual jumpbox infrastructure 108 and the POP device 236.

Although the virtual jumpbox infrastructure 108 is illustrated in FIG. 1 to be external to the cloud-based virtual computer network 102, in other embodiments, the virtual jumpbox infrastructure 108 may reside within the cloud-based virtual computer network 102.

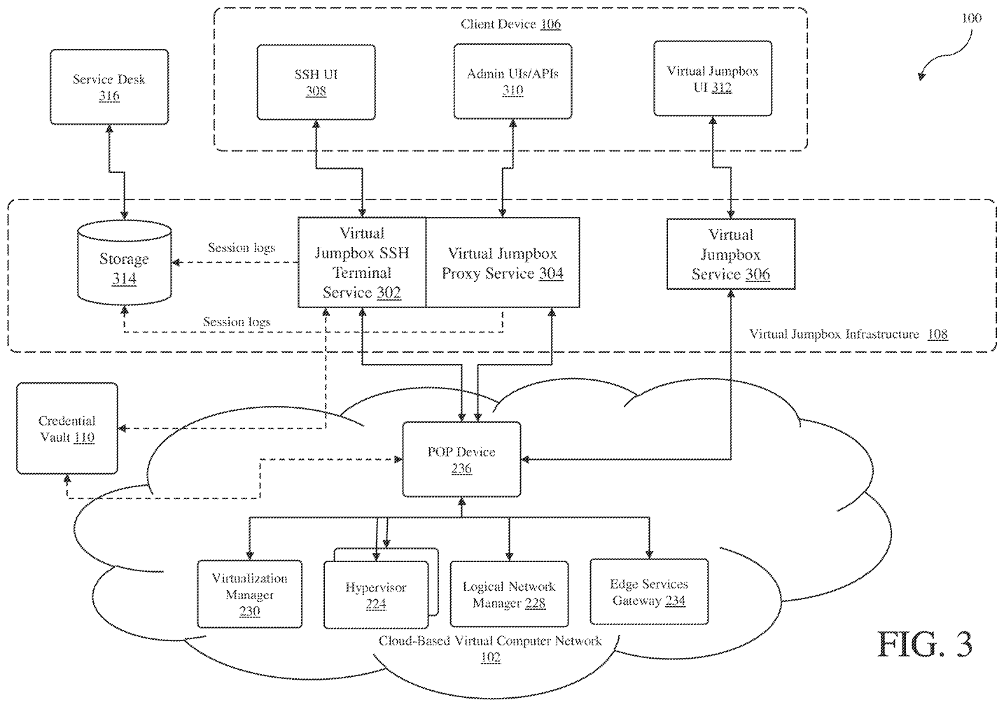

Turning now to FIG. 3, a more detailed diagram of the computing system 100 in accordance with an embodiment of the invention is illustrated. As shown in FIG. 3, the virtual jumpbox infrastructure 108 includes three different services to handle three different types of communications from one of the user devices 106 to the managed components of the cloud-based virtual computer network 102, which are the hypervisors 224, the logical network manager 228, the virtualization manager 230 and the edge services gateway 234 in the illustrated example. The three different services include a virtual jumpbox secure shell (SSH) terminal service 302, a virtual jumpbox proxy service 304 and a virtual jumpbox service 306.

The virtual jumpbox service 306 is an authorization/authentication service for users to access the managed components of the cloud-based virtual computer network 102 via the POP device 236 for certain purposes, such as to troubleshoot some issues in the cloud-based virtual computer network. Specifically, the virtual jumpbox service 306 operates to authenticate, authorize and allow access for users to the managed components of the cloud-based virtual computer network 102. In an embodiment, the authentication may be executed using an external multi-factor authentication (MFA) service. The virtual jumpbox service 306 may be accessed using a virtual jumpbox user interface (UI) 312, which may be a browser-based UI. In an embodiment, the virtual jumpbox UI 312 communicates with the virtual jumpbox service 306 using Hyper Text Transfer Protocol (HTTP) or Hyper Text Transfer Protocol Secure (HTTPS). The virtual jumpbox service 306 may communicate with the POP device 236 through any appropriate connection, including HTTP or HTTPS connection. The virtual jumpbox service 306 can also be used to determine what moderation rules apply for the specific user session. For example, operators with sensitive permissions may see more information than those that have just read and write permissions. This is done even though the authentication to the target system is via shared admin account, such as root.

The virtual jumpbox proxy service 304 is a proxy service for users that are using administration Uls and/or Application Programming Interfaces (APIs) 310 to access the managed components of the cloud-based virtual computer network 102 via the POP device 236. The virtual jumpbox proxy service 304 can moderate access to specific UIs or APIs, even though privileged admin accounts can be used on the target system. In an embodiment, the virtual jumpbox proxy service 304 uses L7 (application) proxy to interface with the POP device 236. As the virtual jumpbox proxy service 304 operates as a proxy for the administration UIs/APIs 310, session logs for communications between administration UIs/APIs 310 and the managed components of the cloud-based virtual computer network 102 are created and stored in session log storage 314. The session logs may include various session data related to the communications, including identification (ID) of the current user, keystrokes of the user during the session and all information sent and received in the session. In an embodiment, the administration UIs/APIs 310 may include web-based UIs, which may be running on the user device 106, that are specifically designed for certain managed components of the cloud-based virtual computer network 102. Thus, the connections from the administration UIs/APIs 310 to the POP device 236 via the virtual jumpbox proxy service 304 may be HTTP or HTTPS connections.

The virtual jumpbox SSH terminal service 302 operates to allow users to open SSH sessions using an SSH UI 308 to access the managed components 104 of the cloud-based virtual computer network 102 via the POP device 236. The SSH UI 308 may be a web-based UI or a downloadable executable running on the user device 106. In an embodiment, the SSH UI may be or a part of an operations console running on the user device 106. In an embodiment, the SSH UI 308 communicates with the virtual jumpbox SSH terminal service 302 through an HTTP or HTTPS connection, while the virtual jumpbox SSH terminal service 302 communicates with the POP device 236 through an SSH connection. Session logs of SSH connections are stored in the session log storage 314 by the virtual jumpbox SSH terminal service 302 for auditing purposes. The session logs may include various data related to each SSH session conducted via the virtual jumpbox SSH terminal service 302, such as ID of the current user, keystrokes of the user during the session and all information sent and received in the session, which results in non-repudiation.

The virtual jumpbox SSH terminal service 302 allows access to various managed components of the cloud-based virtual computer network 102 via shared accounts, such as a root account. In addition, the virtual jumpbox SSH terminal service 302 provides a full audit trail for everything performed within each SSH session, which includes the ability to record and playback SSH sessions for full input and output auditing, i.e., not only what the operators enter, but also what they see. Additionally, the virtual jumpbox SSH terminal service 302 removes the need for an administrator to have knowledge of access information, such as credentials and keys. Furthermore, the virtual jumpbox SSH terminal service 302 can limit the scope of commands that can be executed for certain accounts and/or replace commands with well-known and audited macros to achieve the same function. As shown in FIG. 3, the virtual jumpbox SSH terminal service 302 uses the credential vault 110 to insert and detect sensitive information, such as passwords, in data streams to and from the target systems. The credential vault is also used by the virtual jumpbox SSH terminal service 302 and the POP device to create the trust between the virtual jumpbox SSH terminal service 302 and the POP device. The virtual jumpbox SSH terminal service 302 is described in more detail below.

In the illustrated embodiment, the session logs stored in the session log storage 314 may be used by a service desk 316 to resolve end user issues for the cloud-based virtual computer network 102. In some embodiments, the service desk 316 may also provide approvals for users to use the virtual jumpbox service 306 to access the managed components of the cloud-based virtual computer network 102.

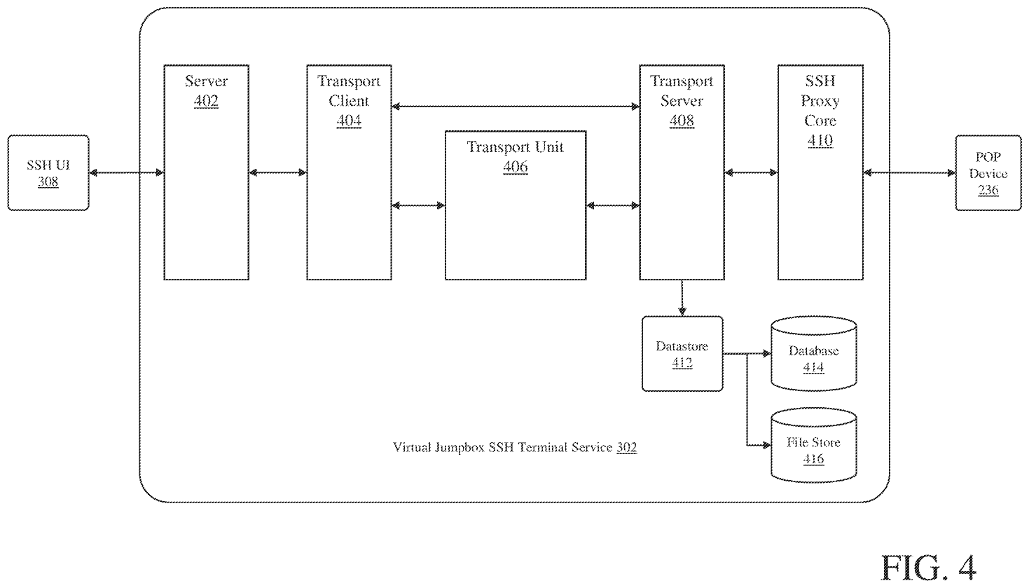

Turning now to FIG. 4, components of the virtual jumpbox SSH terminal service 302 of the virtual jumpbox infrastructure 108 in accordance with an embodiment of the invention are illustrated. As shown in FIG. 4, the virtual jumpbox SSH terminal service 302 includes an SSH proxy core 410, which functions as a proxy for an SSH UI 308 running on a user device to open an SSH session with the POP device 236 in the cloud-based virtual computer network 102 to communicate with one or more target managed components in the cloud-based virtual computer network. Thus, the SSH proxy core acts as an SSH client on behalf of the SSH UI 308 to establish an SSH session with the POP device 236, and to transmit data to and receive data from the target managed components in the cloud-based virtual computer network via the POP device 236 through the established SSH session.

The virtual jumpbox SSH terminal service 302 further includes a server 402, which interfaces with the SSH UI 308. In some embodiments, the server 402 is a web or HTTP server. In operation, the server 402 receives communications from the SSH UI 308, including a request to open an SSH session and, after an SSH session has been opened by the SSH proxy core, outgoing (input) communications from the SSH UI 308 to one or more target managed components in the cloud-based virtual computer network 102 via the POP device 236. The server 402 also transmits incoming (output) communications from the target managed components in the cloud-based virtual computer network 102 via the POP device 236 to the SSH UI 308 through the SSH proxy core 410. In an embodiment, the outgoing (input) and incoming (output) communications are transmitted between the SSH UI 308 and the server 402 over a websocket.

As shown in FIG. 4, the virtual jumpbox SSH terminal service 302 also includes a transport client 404, a transport unit 406 and a transport server 408 that are situated between the server 402 and the SSH proxy core 410. These components of the virtual jumpbox SSH terminal service 302 provide a mechanism to transport data between the server 402 and the SSH proxy core 410. The transport client 404 receives data from the server 402 and transports the data to the transport server 408 and vice versa. Communications related to establishing an SSH session are transported directly from the transport client 404 to the transport server 408 without going through the transport unit 406. These communications include a request to open an SSH session from the SSH UI 308 and metadata of the SSH session when the SSH session has been established. The metadata of the SSH session may include session ID, type of session and target information of the session, for example, name and ID of the cloud-based virtual computer network 102 (e.g., SDDC name and SDDC ID). In an embodiment, the transport client 404 allows the SSH UI 308 and/or other SSH UIs to register with the transport client using the session ID of the established SSH connection to transmit and receive data through the established SSH connection.

When an SSH session is established, outgoing (input) data from the registered SSH UI 308 to one or more target managed component in the cloud-based virtual computer network 102 is transported through the transport client 404 to the transport server 408 via the transport unit 406. Similarly, when an SSH session is established, incoming (output) data from one or more target managed component to the SSH UI 308 is transported through transport server 408 to the transport client 404 via the transport unit 406. In an embodiment, at the transport client, the incoming (output) data is routed to all the registered SSH UIs.

In addition to passing data to the transport client 404 and the SSH proxy core 410, the transport server 408 also records information regarding all input and output communications in one or more datastores 412 as session logs. As noted previously, the session logs may include various data related to all input and output communications, including ID of the current user, keystrokes of the user during the session and all information sent and received in the session. The transport server 408 also saves files received from the target managed components to provide a secure copy (SCP) feature for the user of the SSH UI 308. In a particular implementation, a database 414 may be used to store the session logs, and a file store 416 may be used to store files for SCP. The database 414 and the file store 416 may be stored in the session log storage 314 or in any other computer storage. The session logs stored in the database 414 can be used to audit user access and interactions with the managed components in the cloud-based virtual computer network 102.

The transport unit 406 operates to moderate input and output communications being transported between the transport client 404 and the transport server 408 to selectively manipulate information contained in the communications. In some embodiments, the transport unit 406 may add and/or delete sensitive information in the input and output communications so that the sensitive information is not exposed to the SSH UI 308. The transport unit 406 may also insert and/or substitute certain variables in the communications to allow, for example, passwords to be referenced without knowledge of the actual passwords. The transport unit 406 may also replace custom command aliases with actual commands so that the user does not have to know the actual commands.

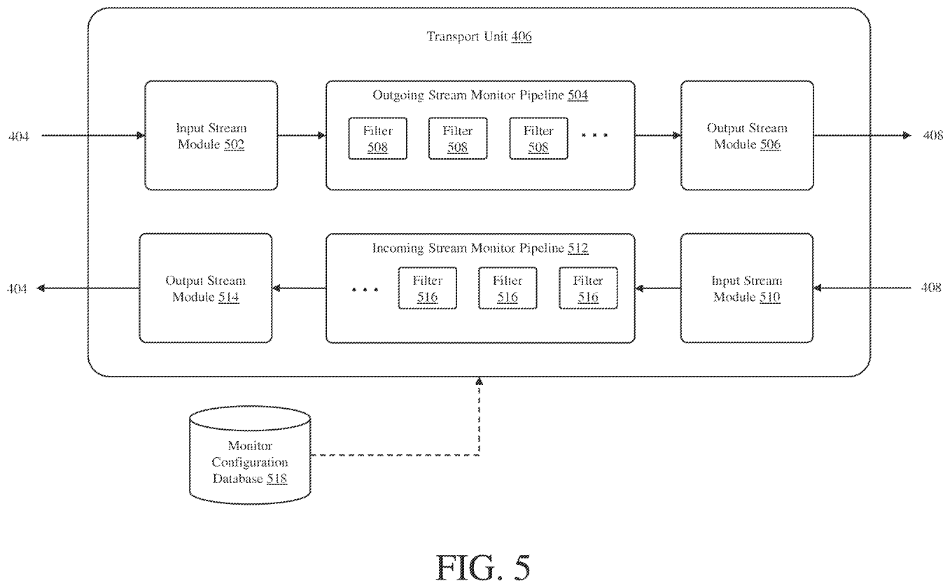

Turning now to FIG. 5, components of the transport unit 406 in accordance with an embodiment of the invention are illustrated. As shown in FIG. 5, the transport unit 406 includes an input stream module 502, an outgoing stream monitor pipeline 504 and an output stream module 506, which operate on outgoing (input) communications from the SSH UI 308. The input stream module 502 operates to receive the outgoing (input) communications from the SSH UI 308 via the transport client 404 and transmits the received communications to the outgoing stream monitor pipeline 504 to be processed. At the outgoing stream monitor pipeline 504, the outgoing (input) communications are subjected to various moderation operations, such as adding sensitive information into the data streams or substituting variables in the data streams with proper information. Thus, new information can be added to the outgoing (input) communications before the outgoing (input) communications are transmitted through the established SSH connection, i.e., at a data path that is not within the established SSH connection.

In the illustrated embodiment, the outgoing stream monitor pipeline 504 includes one or more filters 508 to execute the various moderation operations on the outgoing data streams. Each filter 508 may be configured or programmed to execute a particular moderation operation. These moderation operations may include adding particular information to the outgoing (input) communications so that the users do not have to have knowledge of the particular information. The added information may be sensitive information, such as login credentials for shared accounts or keys, or specific commands. The following are examples of moderation operations that may be performed by the filters 508 in the outgoing stream monitor pipeline 504.

In a first example, one or more of the filters 508 in the outgoing stream monitor pipeline 504 may replace variables, which are provided by users instead of sensitive information, with actual values of the sensitive information, such as username and password, before being transmitted through the established SSH connection to a target managed component in the cloud-based virtual computer network 102 via the POP device 236. As an example, the user input of an actual command “curl---useradministrator@vmc.local:secret h-t-t-p-s://vcenter.sddc-44-236-216-55.vmwarevmc.com/” may be “>$curl--user{{vc.admin.user}}:{{vc.admin.password}}h-t-t-p-s://vcenter.sddc-44-236-216-55.vmwarevmc.com/,” where “vc.admin.user” and “vc.admin.password” are variables. The following will be what the user will see after providing the right variables: “>$curl--user*******:*******h-t-t-p-s://vcenter.sddc-44-236-216-55.vmwarevmc.com/” The variables in the command will be replaced with actual values for username and password by one or more of the filters 508.

In a second example, one or more of the filters 508 in the outgoing stream monitor pipeline 504 may replace custom command aliases with actual commands before being transmitted through the established SSH connection to a target managed component in the cloud-based virtual computer network 102 via the POP device 236. As an example, to find all running java processes on a system, one has to use the command “ps-ef|grep java|grep-v grep.” This actual command could be assigned with a custom command alias of“[[java process]], which will be replaced with the actual command by a filter in the outgoing stream monitor pipeline 504. In this example, the user input to find all java processes will be “>$[[Java process]].” This user input will be replaced with “>$ps-ef|grep Java|grep-v grep” by one of the filters 508 in the outgoing stream monitor pipeline 504.

Additional examples of moderation operations that may be performed by the filters 508 in the outgoing stream monitor pipeline 504 include allowing hotkeys to be used for entering sensitive information at prompts, e.g., if authentication to internal database is required. Another example is removal or flagging of specific command usage, such as rm-rf*. This may be done using regular expression (regex) patterns to detect allowed commands and formats. Still another example is command filtering, which involves allowing certain commands but not others, e.g., prevent ssh access from one machine to another by blocking ssh completely. Still another example is providing SDDC specific configuration information at the command prompt, such as Internet Protocol (IP) addresses of components, or other information that are stored within the cloud service.

After the data streams have been processed by the filters 508 of the outgoing stream monitor pipeline 504, the processed data streams are received by the output stream module 506, which transmits the processed data streams to the SSH proxy core 410 via the transport server 408. Thus, the outgoing (input) data that is transmitted through the SSH connection will include proper sensitive information and/or commands that is needed for successful communication.

As shown in FIG. 5, the transport unit 406 further includes an input stream module 510, an incoming stream monitor pipeline 512 and an output stream module 514, which operate on incoming (output) communications to the SSH UI 308. The input stream module 510 operates to receive the incoming (output) communications from a target managed component in the cloud-based virtual computer network 102 via the transport server 408 and transmits the received communications to the incoming stream monitor pipeline 512 to be processed. At the incoming stream monitor pipeline 512, the incoming (output) communications are subjected to one or more moderation operations, such as removing sensitive information from the data streams. Thus, existing information can be removed from the incoming (output) communications after the incoming (output) communications have been transmitted through the established SSH connection, i.e., at a data path that is not within the established SSH connection. In an embodiment, when sensitive information is removed from the incoming (output) data, new information may be added in place of the sensitive information to indicate that the sensitive information has been removed.

In the illustrated embodiment, the incoming stream monitor pipeline 512 includes one or more filters 516 to execute the various moderation operations on the incoming data streams. Each filter 516 may be configured or programmed to execute a particular moderation operation. These moderation operations may include removing particular information from the incoming (output) communications so that the users do not have access to the particular information, which may involve filtering for specific strings, i.e., the particular information. The removed information may be sensitive information, such as login credentials, e.g., passwords. These moderation operations may also involve filtering on regular expressions (regex).

After the data streams have been processed by the filters 516 of the incoming stream monitor pipeline 512, the processed data streams are received by the output stream module 514, which transmits the processed data streams to the server 402 via the transport client 404. Thus, the incoming (output) data that is transmitted to the SSH UI 308 will not include sensitive information for compliance and security.

In an embodiment, the configurations of the outgoing and incoming stream monitor pipelines 504 and 512 are dynamic, allowing the filters 508 and 516 in the stream monitor pipelines to be configured based on session type, user access or other requirements. The stream monitor pipelines may be configured as part of session setup between the a client, i.e., the SSH UI 308, and a target, i.e., the virtual jumpbox SSH terminal service 302. The configuration information needed to configure the filters of the stream monitor pipelines may be stored in a monitor configuration database 518. In some embodiments, the stream monitor pipelines may be used for other tasks, such as secure file transfer and session input/output (I/O) monitoring for audits and compliance purposes.

In some embodiments, the components of the virtual jumpbox infrastructure 108, which include the components of the virtual jumpbox SSH terminal service 302, may be implemented as containerized applications running on one or more Kubernetes clusters. However, in other embodiments, these components may be implemented as applications running on other platforms.

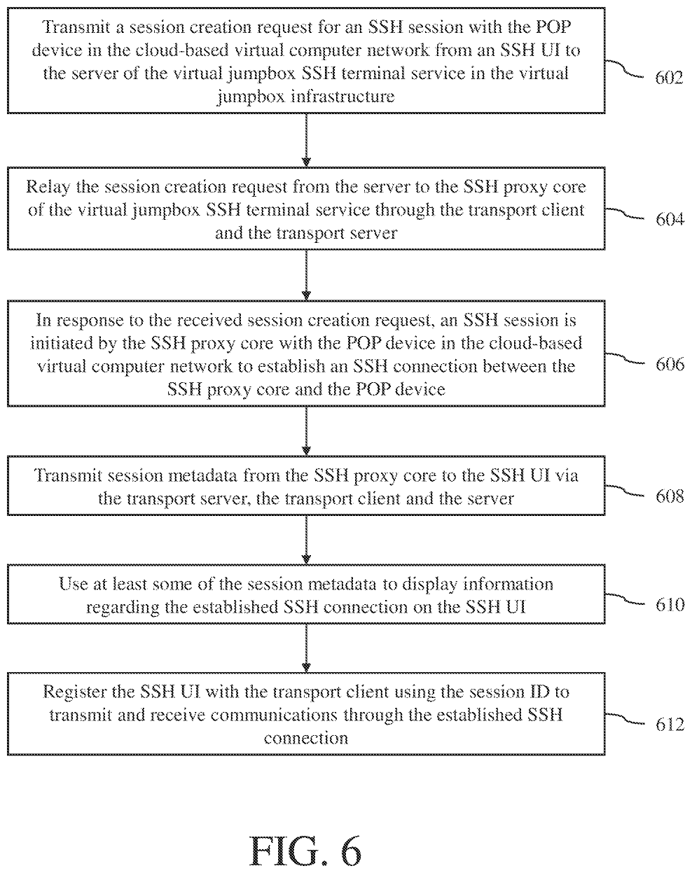

Turning now to FIG. 6, a flow diagram of a process of creating an SSH session with the POP device 236 in the cloud-based virtual computer network 102 from an SSH UI 308 to remotely access target managed components 104 in the cloud-based virtual computer network in accordance with an embodiment of the invention is shown. The process begins at step 602, where a session creation request for an SSH session with the POP device 236 in the cloud-based virtual computer network is transmitted from the SSH UI 308 in one of the user devices 106 to the server 402 of the virtual jumpbox SSH terminal service 302 in the virtual jumpbox infrastructure 108. In an embodiment, the session creation request may include at least an ID of the user making the request, an ID of the SSH UI 308, and an ID of the cloud-based virtual computer network 102. It is assumed here that the user is an authorized user to access the virtual jumpbox infrastructure 108, which may have been granted using, for example, an access token.

Next, at step 604, the session creation request is relayed from the server 402 to the SSH proxy core 410 of the virtual jumpbox SSH terminal service 302 through the transport client 404 and the transport server 408. In an embodiment, as illustrated in FIG. 4, the session creation request is transmitted through the path that does not go through the transport unit 406.

Next, at step 606, in response to the received session creation request, an SSH session is initiated by the SSH proxy core 410 with the POP device 236 in the cloud-based virtual computer network 102 to establish an SSH connection between the SSH proxy core 410 and the POP device 236. The process of establishing an SSH connection, which includes an input channel and an output channel, is well known, and thus, not described herein in detail.

Next, at step 608, metadata of the established SSH connection (“session metadata”) is transmitted from the SSH proxy core 410 to the SSH UI 308 via the transport server 408, the transport client 404 and the server 402. The session metadata may include various information regarding the established SSH connection, which includes, for example, session ID, type of session and target information of the session, for example, name and ID of the cloud-based virtual computer network 102 (e.g., SDDC name and SDDC ID).

Next, at step 610, at least some of the session metadata are used to display information regarding the established SSH connection on the SSH UI 308.

Next, at step 612, the SSH UI 308 is registered with the transport client 404 using the session ID to transmit and receive communications through the established SSH connection. In an embodiment, other SSH UIs may also be allowed to register with the transport client 404 using the session ID to transmit and receive communications through the same established SSH connection. Thus, in this embodiment, the transport client 404 ensures that outgoing (input) communications from the registered SSH UIs are transmitted through the SSH connection corresponding to the session ID used for registration, and that incoming (output) communications from the same SSH connection are transmitted to the registered SSH UIs.

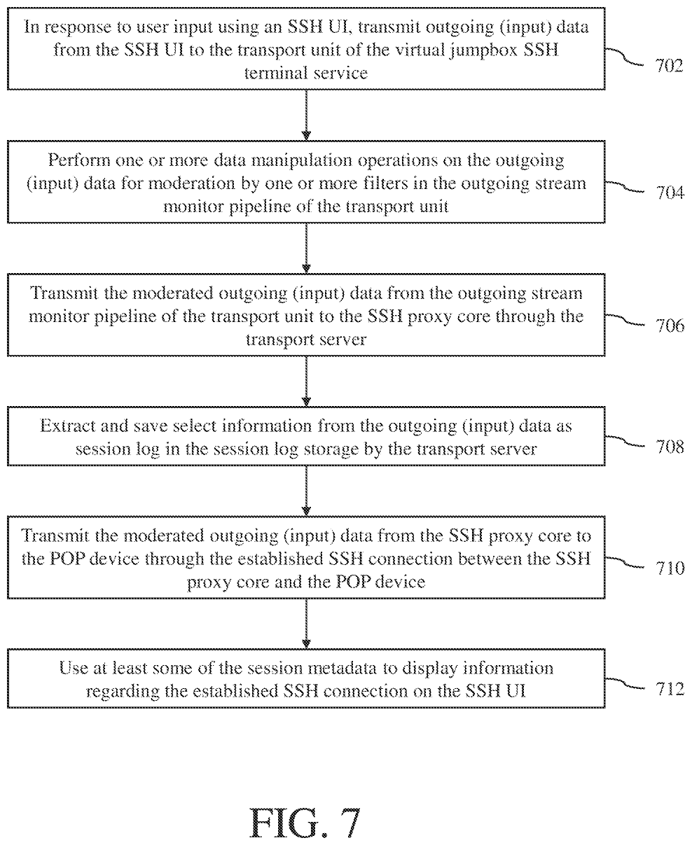

Turning now to FIG. 7, a flow diagram of a process of sending outgoing (input) data from a registered SSH UI 308 to a target managed component in the cloud-based virtual computer network 102 through an established SSH session between the SSH proxy core 410 in the virtual jumpbox SSH terminal service 302 and the POP device 236 in the cloud-based virtual computer network in accordance with an embodiment of the invention is shown. This process begins at step 702, where, in response to user input using the SSH UI 308, outgoing (input) data is transmitted from the SSH UI to the transport unit 406 of the virtual jumpbox SSH terminal service 302 via the server 402 and the transport client 404.

Next, at step 704, one or more data manipulation operations are performed on the outgoing (input) data for moderation by one or more filters 508 in the outgoing stream monitor pipeline 504 of the transport unit 406. As an example, these data manipulation operations may include replacing particular variables in the outgoing (input) data with sensitive information, such as username and password for a shared account, or replacing a particular command alias in the outgoing (input) data with an actual command that has been assigned to the particular command.

Next, at step 706, the moderated outgoing (input) data is transmitted from the outgoing stream monitor pipeline 504 of the transport unit 406 to the SSH proxy core 410 through the transport server 408. At step 708, select information is extracted from the moderated outgoing (input) data and saved as session log in the session log storage 314 by the transport server.

Next, at step 710, the moderated outgoing (input) data is transmitted from the SSH proxy core 410 to the POP device 236 through the established SSH connection between the SSH proxy core 410 and the POP device 236. In an embodiment, the outgoing (input) data is transmitted from the SSH UI 308 to the SSH proxy core 410 using HTTP or HTTPS.

Next, at step 712, the moderated outgoing (input) data is transmitted from the POP device 236 to the target managed component in the cloud-based virtual computer network 102. Any network connection may be used to transmit the moderated outgoing (input) data from the POP device 236 to the target managed component.

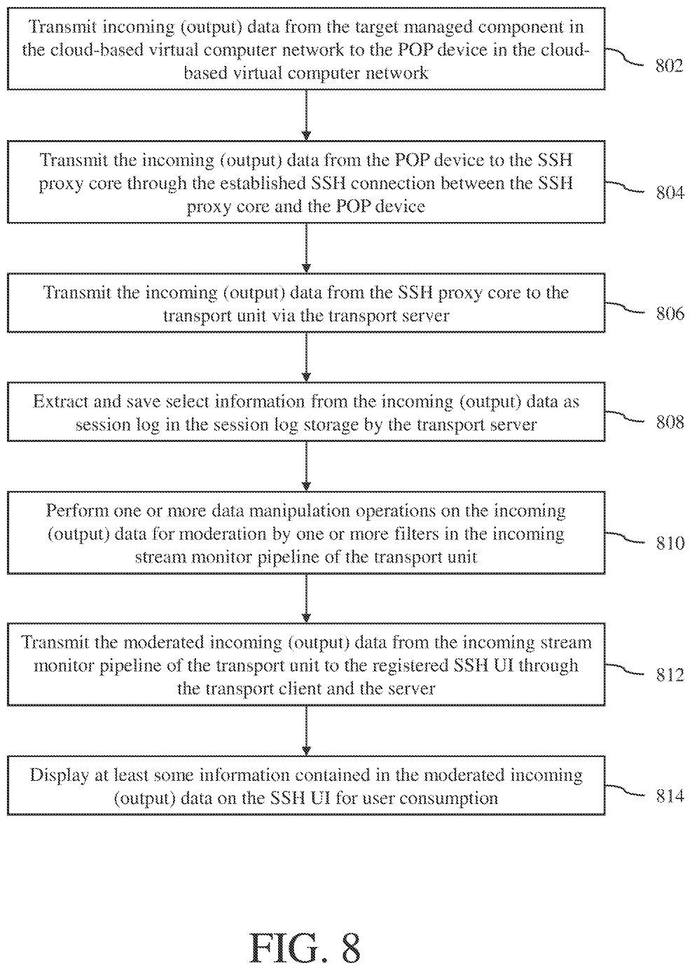

Turning now to FIG. 8, a flow diagram of a process of receiving incoming (output) data from a target managed component in the cloud-based virtual computer network 102 to an SSH UI 308 through an established SSH session between the SSH proxy core 410 in the virtual jumpbox SSH terminal service 302 and the POP device 236 in the cloud-based virtual computer network 102 in accordance with an embodiment of the invention is shown. This process begins at step 802, where incoming (output) data is transmitted from the target managed component in the cloud-based virtual computer network 102 to the POP device 236 in the cloud-based virtual computer network 102.

Next, at step 804, the incoming (output) data is transmitted from the POP device 236 in the cloud-based virtual computer network 102 to the SSH proxy core 410 in the virtual jumpbox SSH terminal service 302 through the established SSH connection between the SSH proxy core 410 and the POP device 236.

Next, at step 806, the incoming (output) data is transmitted from the SSH proxy core 410 to the transport unit 406 via the transport server 408. At step 808, select information is extracted from the incoming (output) data and saved as session log in the session log storage 314 by the transport server 408.

Next, at step 810, one or more data manipulation operations are performed on the incoming (output) data for moderation by one or more filters 516 in the incoming stream monitor pipeline 512 of the transport unit 406. As an example, these data manipulation operations may include removing sensitive information in the incoming (output) data, such as username and password for a shared account.

Next, at step 812, the moderated incoming (output) data is transmitted from the incoming stream monitor pipeline 512 of the transport unit 406 to the registered SSH UI 308 through the transport client 404 and the server 402. In an embodiment, the moderated incoming (output) data is routed to the registered SSH UI 308 by the transport client 404, which maintains the information regarding any SSH UIs registered for the established SSH connection. If more than one SSH UI is registered, then the moderated incoming (output) data is transmitted to all the registered SSH UI in parallel.

Next, at step 814, at least some information contained in the moderated incoming (output) data is displayed on the SSH UI 308 for user consumption. The information displayed on the SSH UI will vary depending on the received data from the target managed component in the cloud-based virtual computer network 102.

Although remote access using the virtual jumpbox SSH terminal service 302 has been described above using an SSH connection, in other embodiments, other cryptographic network protocol connections may be used instead of an SSH connection. Thus, the techniques described herein to record session logs and to moderate remote access communications may be applied to similar systems using another type of cryptographic network protocol connections.

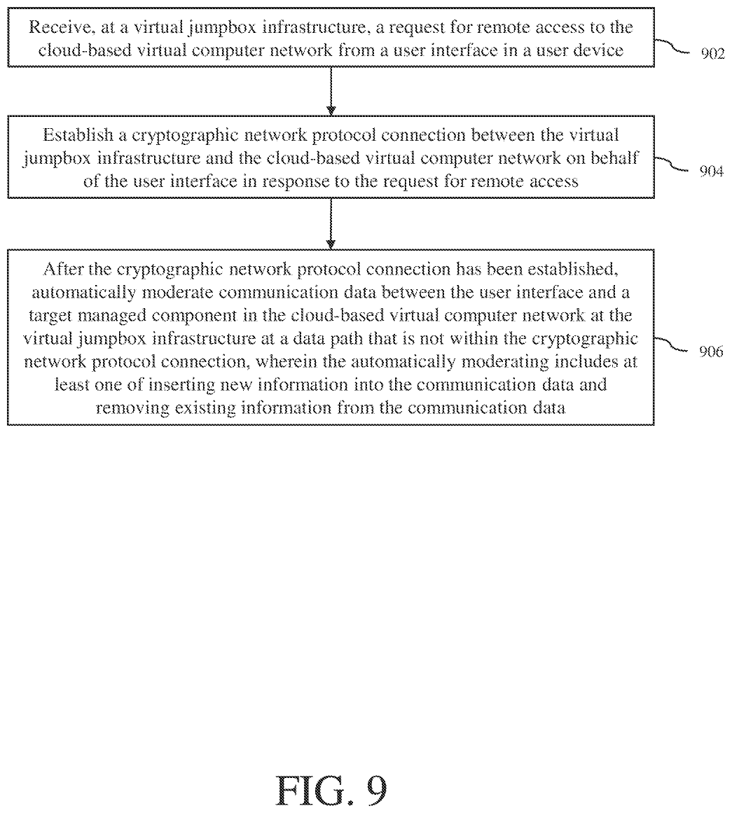

A computer-implemented method for managing remote access to managed components in a cloud-based virtual computer network in accordance with an embodiment of the invention is described with reference to a process flow diagram of FIG. 9. At block 902, a request for remote access to the cloud-based virtual computer network from a user interface in a user device is received at a virtual jumpbox infrastructure. At block 904, a cryptographic network protocol connection is established between the virtual jumpbox infrastructure and the cloud-based virtual computer network on behalf of the user interface in response to the request for remote access. At block 906, after the cryptographic network protocol connection has been established, communication data between the user interface and a target managed component in the cloud-based virtual computer network is automatically moderated at the virtual jumpbox infrastructure at a data path that is not within the cryptographic network protocol connection, wherein the automatically moderating includes at least one of inserting new information into the communication data and removing existing information from the communication data. Session data from the communication data may be saved at the virtual jumpbox infrastructure to provide an audit trail.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for managing remote access to managed components in a cloud-based virtual computer network, the method comprising:
receiving, at a virtual jumpbox infrastructure, a request for remote access to the cloud-based virtual computer network from a user interface in a user device;
establishing a cryptographic network protocol connection between the virtual jumpbox infrastructure and the cloud-based virtual computer network on behalf of the user interface in response to the request for remote access; and
after the cryptographic network protocol connection has been established, automatically moderating communication data between the user interface and a target managed component in the cloud-based virtual computer network at the virtual jumpbox infrastructure at a data path that is not within the cryptographic network protocol connection, wherein the automatically moderating includes at least one of inserting new information into the communication data and removing existing information from the communication data.

2. The computer-implemented method of claim 1, further comprising saving session data from the communication data at the virtual jumpbox infrastructure to provide an audit trail.

3. The computer-implemented method of claim 1, wherein establishing the cryptographic network protocol connection includes establishing a secure shell (SSH) connection between the virtual jumpbox infrastructure and the cloud-based virtual computer network on behalf of the user interface in response to the request for remote access.

4. The computer-implemented method of claim 3, wherein establishing the SSH connection includes establishing the SSH connection between an SSH proxy core in the virtual jumpbox infrastructure and a point-of-presence (POP) device in the cloud-based virtual computer network on behalf of the user interface in response to the request for remote access.

5. The computer-implemented method of claim 1, wherein automatically moderating the communication data includes inserting actual values of sensitive information into outgoing communication data from the user interface to replace a variable in the outgoing communication data at the virtual jumpbox infrastructure before the outgoing communication data is transmitted through the cryptographic network protocol connection.

6. The computer-implemented method of claim 5, wherein inserting the actual values of sensitive information into the outgoing communication data from the user interface includes inserting login credentials into the outgoing communication data from the user interface to replace the variable in the outgoing communication data at the virtual jumpbox infrastructure before the outgoing communication data is transmitted through the cryptographic network protocol connection.

7. The computer-implemented method of claim 1, wherein automatically moderating the communication data includes inserting an actual command into outgoing communication data from the user interface to replace a custom command alias in the outgoing communication data at the virtual jumpbox infrastructure before the outgoing communication data is transmitted through the cryptographic network protocol connection.

8. The computer-implemented method of claim 1, wherein automatically moderating the communication data includes removing, at the virtual jumpbox infrastructure, sensitive information from incoming communication data from the target managed component that has been transmitted through the cryptographic network protocol connection.

9. The computer-implemented method of claim 1, wherein establishing a cryptographic network protocol connection between the virtual jumpbox infrastructure and the cloud-based virtual computer network includes using a shared account for accessing the cloud-based virtual computer network to establish the cryptographic network protocol connection.

10. The computer-implemented method of claim 1, wherein the target managed component in the cloud-based virtual computer network is a hypervisor, an edge services gateway, a virtualization manager or a logical network manager.

11. The computer-implemented method of claim 1, wherein the cloud-based virtual computer network is virtual private cloud.

12. The computer-implemented method of claim 1, wherein the cloud-based virtual computer network is provided in a public cloud by a cloud service provider.

13. A non-transitory computer-readable storage medium containing program instructions for managing remote access to managed components in a cloud-based virtual computer network, wherein execution of the program instructions by one or more processors causes the one or more processors to perform steps comprising:
receiving, at a virtual jumpbox infrastructure, a request for remote access to the cloud-based virtual computer network from a user interface in a user device;
establishing a cryptographic network protocol connection between the virtual jumpbox infrastructure and the cloud-based virtual computer network on behalf of the user interface in response to the request for remote access; and
after the cryptographic network protocol connection has been established, automatically moderating communication data between the user interface and a target managed component in the cloud-based virtual computer network at the virtual jumpbox infrastructure at a data path that is not within the cryptographic network protocol connection, wherein the automatically moderating includes at least one of inserting new information into the communication data and removing existing information from the communication data.

14. The non-transitory computer-readable storage medium of claim 13, wherein the steps further comprise saving session data from the communication data at the virtual jumpbox infrastructure to provide an audit trail.

15. The non-transitory computer-readable storage medium of claim 13, wherein establishing the cryptographic network protocol connection includes establishing a secure shell (SSH) connection between the virtual jumpbox infrastructure and the cloud-based virtual computer network on behalf of the user interface in response to the request for remote access.

16. The non-transitory computer-readable storage medium of claim 15, wherein establishing the SSH connection includes establishing the SSH connection between an SSH proxy core in the virtual jumpbox infrastructure and a point-of-presence (POP) device in the cloud-based virtual computer network on behalf of the user interface in response to the request for remote access.

17. The non-transitory computer-readable storage medium of claim 13, wherein automatically moderating the communication data includes inserting actual values of sensitive information into outgoing communication data from the user interface to replace a variable in the outgoing communication data at the virtual jumpbox infrastructure before the outgoing communication data is transmitted through the cryptographic network protocol connection.

18. The non-transitory computer-readable storage medium of claim 17, wherein inserting the actual values of sensitive information into the outgoing communication data from the user interface includes inserting login credentials into the outgoing communication data from the user interface to replace the variable in the outgoing communication data at the virtual jumpbox infrastructure before the outgoing communication data is transmitted through the cryptographic network protocol connection.

19. The non-transitory computer-readable storage medium of claim 13, wherein automatically moderating the communication data includes inserting an actual command into outgoing communication data from the user interface to replace a custom command alias in the outgoing communication data at the virtual jumpbox infrastructure before the outgoing communication data is transmitted through the cryptographic network protocol connection.

20. The non-transitory computer-readable storage medium of claim 13, wherein automatically moderating the communication data includes removing, at the virtual jumpbox infrastructure, sensitive information from incoming communication data from the target managed component that has been transmitted through the cryptographic network protocol connection.

21. The non-transitory computer-readable storage medium of claim 13, wherein the cloud-based virtual computer network is provided in a public cloud by a cloud service provider.

22. A system comprising:
memory; and
at least one processor configured to:
receive, at a virtual jumpbox infrastructure, a request for remote access to a cloud-based virtual computer network from a user interface in a user device;
establish a cryptographic network protocol connection between the virtual jumpbox infrastructure and the cloud-based virtual computer network on behalf of the user interface in response to the request for remote access; and
after the cryptographic network protocol connection has been established, automatically moderate communication data between the user interface and a target managed component in the cloud-based virtual computer network at the virtual jumpbox infrastructure at a data path that is not within the cryptographic network protocol connection, wherein the automatically modulate includes at least one of inserting new information into the communication data and removing existing information from the communication data.

23. The system of claim 22, wherein the at least one processor is configured to save session data from the communication data at the virtual jumpbox infrastructure to provide an audit trail.

24. The system of claim 22, wherein the at least one processor is configured to establish a secure shell (SSH) connection between an SSH proxy core in the virtual jumpbox infrastructure and a point-of-presence (POP) device in the cloud-based virtual computer network on behalf of the user interface in response to the request for remote access.

25. The system of claim 24, wherein the at least one processor is configured to insert actual values of sensitive information into outgoing communication data from the user interface to replace a variable in the outgoing communication data at the virtual jumpbox infrastructure before the outgoing communication data is transmitted through the cryptographic network protocol connection to moderate the outgoing communication data.

26. The system of claim 22, wherein the cloud-based virtual computer network is provided in a public cloud by a cloud service provider.
